(19) United States
(12) Patent Application Publication
(10) Pub. No.: US 2010/0242252 A1
(43) Pub. Date: Sep. 30, 2010

(54) METHOD FOR FASTENING A BAND-SHAPED SEAL ON A COMPONENT

(75) Inventor: Christian FOERG, Dillishausen (DE)

Correspondence Address: CROWELL & MORING LLP;INTELLECTUAL PROPERTY GROUP, P.O. BOX 14300, WASHINGTON, DC, 20044-4300, US

(73) Assignee: Hilti Aktiengesellschaft

(21) Appl. No.: 12/749,368

(22) Filed: Mar. 29, 2010

(30) Foreign Application Priority Data
Mar. 30, 2009 (DE) 10 2009 001 961.8

(51) Int. Cl. B23P 11/00

(52) U.S. Cl. 29/428

(57) ABSTRACT

A method for fastening a band-shaped seal on a component for sealing a cable lead-through, having several holding elements, each having a fastening bracket and a holding bracket with a free end. First of all, the seal is laid around the cable, then the free end of each holding element is bent around and arranged on the edge of the seal that faces away from the surface of the structural element. Then each holding element is fixed on the structural element.

This application claims the priority of German Patent Document No. 10 2009 001 961.8, filed Mar. 30, 2009, the disclosure of which is expressly incorporated by reference herein.

### BACKGROUND AND SUMMARY OF THE INVENTION

The invention relates to a method for fastening a band-shaped seal on a structural element.

Cable lead-throughs, for example, for cables, such as pipes, conduits, etc., in a structural element, such as, for example, a wall or ceiling, are sealed so that, in the event of a fire, smoke gas that develops in the process is prevented from passing through this cable lead-through from one room to the adjacent room, for example. A seal containing an intumescent material, such as, for example, expanding graphite, is used as a fire seal, for example.

A fire protection device is known from German Patent Document No. DE 198 52 120 A1, which has as a sealing means a bendable fire protection insert surrounded by a ductile jacket portion as well as several holding elements, each featuring a fastening bracket and a holding bracket with a free end. A prefabricated bend is provided on the free end of the holding bracket, which forms a U-shaped receiving area for gripping around the edge of the sealing means arranged on the cable facing away from the structural element.

The disadvantage of the known attainment is that, in order to adequately fasten the sealing means on the structural element, the holding elements have to be adapted to its design. Adaptations on-site or during assembly, e.g., to the local circumstances, are not possible in this case.

Using a band-shaped sealing means is also known to create a seal for a cable lead-through, which sealing means is made available to the user, for example, as an endless band that can be cut to length, and which, depending on the degree of desired sealing of the cable lead-through, can be wound around the cable in a corresponding number of windings. Several L-shaped holding elements, each having thorn-like penetrating sections on their holding bracket and projecting therefrom, are known from German Patent Document No. DE 102 17 174 A1 for fastening the band-shaped sealing means on the structural element. When arranging these holding elements, the penetrating sections penetrate through a perforated jacket portion that is previously arranged around the band-shaped sealing means into the sealing means. These holding elements guarantee a secure fixation on the structural element of the sealing means arranged on the cable.

The disadvantage of the known attainment is that the thorn-like penetrating sections must have a sufficiently large extension projecting from the holding bracket for secure fastening. In the case of a band-shaped sealing means, which only has a small thickness or is only arranged in a small number of windings on the cable, these holding elements cannot be used for fastening the band-shaped sealing means on the structural element.

The object of the present invention is developing a method for fastening a band-shaped seal on a structural element for sealing a cable lead-through in the structural element, having several holding elements, with this fastening being largely independent of the thickness of the band-shaped seal that is used.

According to the invention, first of all the seal is laid around the cable, then the free end of each holding element is bent to grip around the edge of the seal arranged on the cable facing away from the surface of the structural element and arranged on this edge of the seal and then each holding element is fixed on the structural element.

This method makes it possible to fasten band-shaped seals having varying thicknesses on a structural element or on a substrate. At the same time, one of the holding elements may serve as a closure element for the outer end of the band of the band-shaped seal. An additional, auxiliary fixing element provided on the exterior on the arranged seal, e.g., in the form of a jacket portion made of a perforated metal sheet, is no longer required for an adequate fixation of the seal on the structural element. This method allows single-layer as well as multi-layer seals to be securely fastened on the structural element. In addition, this method also makes armorings, i.e., arrangements of the band-shaped seal, on cables made of a soft material readily possible.

In particular in the case of a band-shaped seal to seal against fire, this advantageously features an externally arranged supporting material, such as, for example, a fabric mat or a metal foil, which in the initial phase of a fire remains in place at least until the intumescent effect of the seal is concluded.

The bent free end of a holding element is slid advantageously between the seal arranged on the cable and the outside wall of the cable, whereby the seal is gripped around completely in this region and can be fixed securely on the structural element.

Penetrating sections are preferably respectively provided on the holding bracket of the holding elements, which penetrate areas of the seal when the holding element is arranged on the seal that is disposed on the cable. The penetrating sections advantageously feature an extension projecting from the holding bracket, which corresponds to a maximum of the thickness of the band-shaped seal being fixed.

The invention is explained in greater detail in the following on the basis of an exemplary embodiment.

### BRIEF DESCRIPTION OF THE DRAWINGS

FIG. 1 is a top view of an assembled sealing arrangement;

FIG. 2 is a partial section through the sealing arrangement according to FIG. 1;

FIG. 3 is a holding element in a perspective view; and

FIG. 4 is a perspective view of the holding element according to FIG. 3 with a bent free end.

### DETAILED DESCRIPTION OF THE DRAWINGS

As a rule, the same parts in the figures are provided with the same reference numbers.

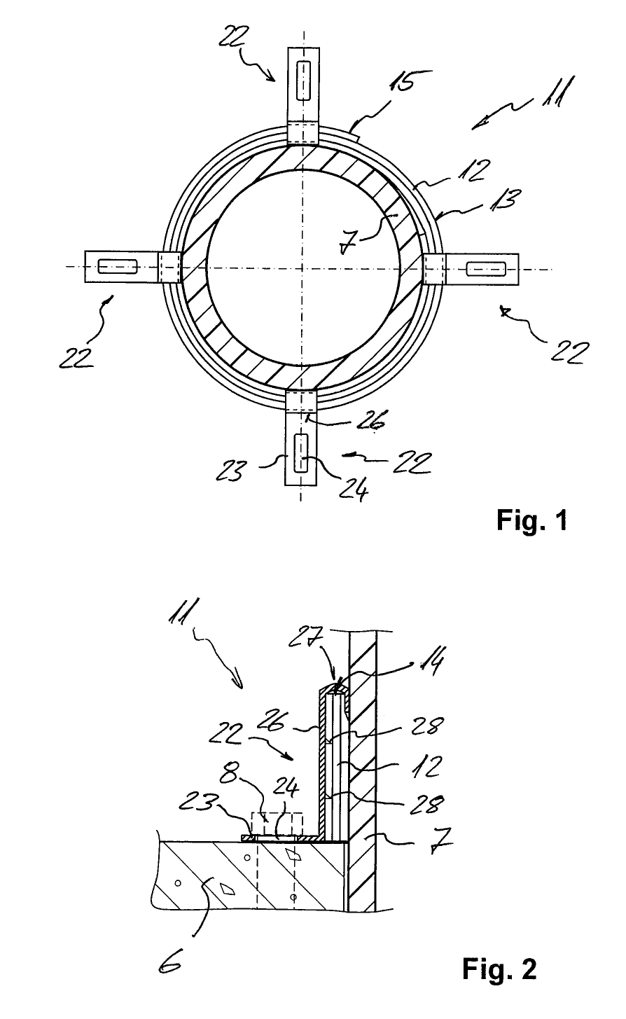

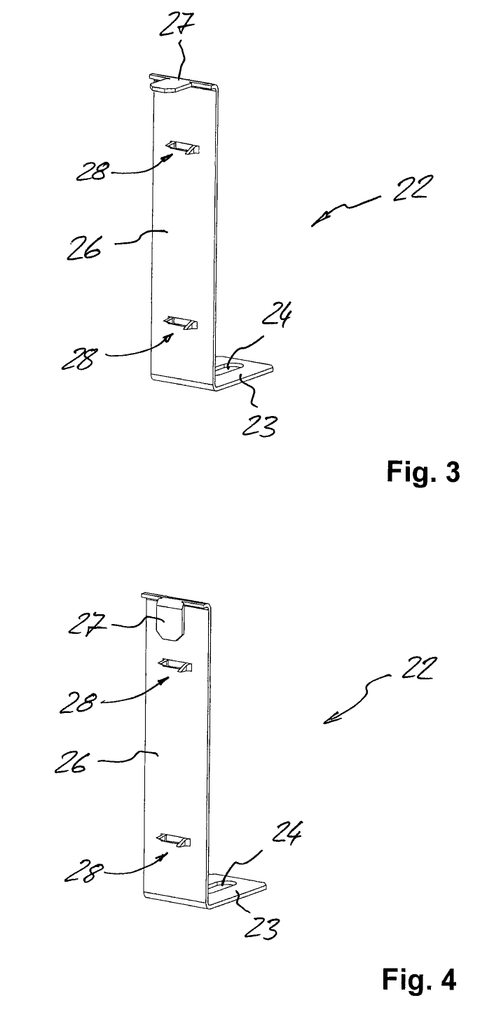

FIGS. 1 and 2 show an assembled sealing arrangement 11 for sealing a member 7, e.g., a cable, pipe, conduit, etc., fed through a structural element 6 as a fire protection device. The sealing arrangement 11 includes a band-shaped seal 12, which features intumescent material and is provided on the outer side with a fabric material 13. Furthermore, the sealing arrangement 11 includes several holding elements 22, each of which has a fastening bracket 23 and a holding bracket 26 with a free end 27. A long hole 24 is provided in the fastening bracket 23 for feeding through a fastener 8 for fixing the holding element 22 on the structural element 6. The width of the free end 27 of the holding bracket 26 is configured to be smaller than the normal holding bracket 26 (see FIGS. 3 and 4), with a target bending point being configured in this region thereby making the free end 27 easy to bend. The holding elements 22 are sheet metal parts, which are manufactured in a punching/bending process.

To fasten the band-shaped seal 12 on the structural element 6, the seal 12 is first wound around the cable 7 several times. Then the free end 27 of each holding element 22 is bent to grip around the edge 14 of the seal 12 arranged on the cable 7 facing away from the surface of the structural element and arranged on this edge 14 of the seal 12. The bent free end 27 of each holding element 22 is slid between the seal 12 arranged on the cable 7 and the outside wall of the cable 7 (see FIG. 2).

A holding element 22 is provided in the region of the end of the band 15, so that the holding element simultaneously serves as a closure element for the wound seal 12. The remaining holding elements 22 are distributed circumferentially in a uniform manner on the seal 12 arranged on the cable 7. Then each holding element 22 is fixed to the structural element 6, for example, with a concrete screw as a fastener 8.

The free end 27 of each holding element 22 is advantageously bent in such a way that the holding element grips around the edge 14 of the seal 12 clamping it in areas when the holding element 22 is in an arranged state. In a further advantageous embodiment (not shown here), the end region of the free end 27 is provided with several target bending points spaced apart from one another, which can be used to easily adapt the holding element 22 to the corresponding number of layers as well as to the corresponding wound width of the band-shaped seal 12.

Penetrating sections 28 are provided on the holding bracket 26 of each holding element 22, which penetrate areas of the seal when the holding element 22 is arranged on the seal 12 and additionally fix the seal.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for fastening a band-shaped seal on a component, comprising the steps of:
bending a free end of a holding element around an edge of a band-shaped seal wrapped around a member disposed through the component, wherein the free end of the holding element is disposed away from a surface of the component; and
fixing the holding element on the component.

2. The method according to claim 1, further comprising the step of sliding the bent free end of the holding element between the wrapped band-shaped seal and an outside wall of the member.

3. The method according to claim 1, further comprising the step of penetrating the wrapped band-shaped seal by a penetrating section of a holding bracket of the holding element.

4. A method for sealing a member disposed through a component, comprising the steps of:
wrapping a band-shaped seal around the member disposed through the component;
bending a free end of a holding element around an edge of the wrapped band-shaped seal, wherein the free end of the holding element is disposed away from a surface of the component; and
fixing the holding element on the component.

5. The method according to claim 4, further comprising the step of sliding the bent free end of the holding element between the wrapped band-shaped seal and an outside wall of the member.

6. The method according to claim 4, further comprising the step of penetrating the wrapped band-shaped seal by a penetrating section of a holding bracket of the holding element.
